(19) United States
(12) Patent Application Publication
(10) Pub. No.: US 2026/0046607 A1
(43) Pub. Date: Feb. 12, 2026

(54) APPARATUS AND METHOD FOR GENERATING TRANSMIT AND RECEIVE SIGNALS IN WIRELESS COMMUNICATION SYSTEM

(71) Applicant: LG Electronics Inc., Seoul (KR)

(72) Inventors: Ikjoo JUNG, Seoul (KR); Sangrim LEE, Seoul (KR); Ki Jun JEON, Seoul (KR); Tae Hyun LEE, Seoul (KR)

(21) Appl. No.: 19/101,753

(22) PCT Filed: Aug. 8, 2022
(86) PCT No.: PCT/KR2022/011784

§ 371 Date: Feb. 6, 2025

(51) Int. Cl. H04W 8/22; H04L 5/00; H04W 76/10

(52) U.S. Cl. CPC H04W 8/22; H04L 5/0048; H04W 76/10

(57) ABSTRACT

The present disclosure may provide a method for operating a first device in a wireless communication system. The method may include receiving, by the first device, a capability information request for the first device from a second device, transmitting capability information of the first device to the second device, in case that the first device being a device equipped with a semantic communication capability based on the capability information of the first device, receiving semantic communication-related information from the second device, generating a semantic communication signal based on the semantic communication-related information, and transmitting the semantic communication signal to the second device. Herein, the semantic communication signal is related to share information, and an update of the share information may be performed based on an operation of a downstream task performed in the second device.

### TECHNICAL FIELD

The present disclosure relates to a wireless communication system, and more particularly, to an apparatus and method for generating transmit and receive signals in a wireless communication system.

Specifically, the present disclosure may provide a method and apparatus for performing a downstream task based on a task-oriented operation in semantic communication. In addition, the present disclosure may provide a method and apparatus for generating a signal for performing a downstream task in a task-orient way through semantic source coding.

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systens considering services/user equipments (UEs) sensitive to reliability and latency have been proposed. To this end, various technical configurations have been proposed.

### DISCLOSURE

### Technical Problem

The present disclosure relates to an apparatus and method for generating a transmission/reception signal in a wireless communication system.

The present disclosure may provide an apparatus and method for transmitting and receiving a signal between semantic layers located in a source and a destination in a wireless communication system.

The present disclosure may provide an apparatus and method for learning a method for generating a signal by using contrastive learning in a wireless communication system.

The present disclosure may provide a method for generating a signal for performing a downstream task of a destination in a wireless communication system.

The present disclosure may provide an apparatus and method for updating background knowledge held in a source and a destination in a wireless communication system.

The present disclosure may provide an apparatus and method for updating learning information to generate a signal in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a first device in a wireless communication may include receiving a capability information request for the first device from a second device, transmitting capability information of the first device to the second device, in case that the first device being a device equipped with a semantic communication capability based on the capability information of the first device, receiving semantic communication-related information from the second device, generating a semantic communication signal based on the semantic communication-related information, and transmitting the semantic communication signal to the second device. Herein, the semantic communication signal is related to share information, and an update of the share information may be performed based on an operation of a downstream task performed in the second device.

As an example of the present disclosure, a method for operating a second device in a wireless communication may include transmitting a capability information request to a first device, receiving capability information from the first device, in case that the first device being a device equipped with a semantic communication capability based on the capability information of the first device, transmitting semantic communication-related information to the first device, and receiving a semantic communication signal generated based on the semantic communication-related information from the first device. Herein, the semantic communication signal is related to share information, and an update of the share information may be performed based on an operation of a downstream task performed in the second device.

As an example of the present disclosure, a first device in a wireless communication system may include a transceiver and a processor coupled with the transceiver, and the processor may be configured to receive a capability information request for the first device from a second device, to transmit capability information of the first device to the second device, in case that the first device being a device equipped with a semantic communication capability based on the capability information of the first device, to receive semantic communication-related information from the second device, to generate a semantic communication signal based on the semantic communication-related information, and to transmit the semantic communication signal to the second device. Herein, the semantic communication signal is related to share information, and an update of the share information may be performed based on an operation of a downstream task performed in the second device.

As an example of the present disclosure, a second device in a wireless communication system may include a transceiver and a processor coupled with the transceiver, and the processor may be configured to transmit a capability information request to a first device, to receive capability information from the first device, in case that the first device being a device equipped with a semantic communication capability based on the capability information of the first device, to transmit semantic communication-related information to the first device, and to receive a semantic communication signal generated based on the semantic communication-related information from the first device. Herein, the semantic communication signal is related to share information, and an update of the share information may be performed based on an operation of a downstream task performed in the second device.

As an example of the present disclosure, a first device may include at least one memory and at least one processor functionally coupled with the at least one memory, and the processor may control the first device to receive a capability information request for the first device from a second device, to transmit capability information of the first device to the second device, in case that the first device being a device equipped with a semantic communication capability based on the capability information of the first device, to receive semantic communication-related information from the second device, to generate a semantic communication signal based on the semantic communication-related information, and to transmit the semantic communication signal to the second device. Herein, the semantic communication signal is related to share information, and an update of the share information may be performed based on an operation of a downstream task performed in the second device.

As an example of the present disclosure, a non-transitory computer-readable medium storing at least one instruction may include the at least one instruction that is executable by a processor, and the at least one instruction may be configured to receive a capability information request from a second device, to transmit capability information to the second device, in case that the computer-readable medium being a medium equipped with a semantic communication capability based on the capability information, to receive semantic communication-related information from the second device, to generate a semantic communication signal based on the semantic communication-related information, and to transmit the semantic communication signal to the second device. Herein, the semantic communication signal is related to share information, and an update of the share information may be performed based on an operation of a downstream task performed in the second device.

As an example of the present disclosure, the semantic communication signal may be used by the second device to perform a downstream task without being decoded to raw data that a first device uses to generate a representation.

As an example of the present disclosure, the capability information is information for determining whether the first device is capable of performing semantic communication, and the capability information may include a type of raw data, which the first device is capable of processing, and operation capability information of the first device.

As an example of the present disclosure, the semantic communication-related information may include at least one of a semantic data acquisition unit, a mini-batch size, an augmentation type and an augmentation ratio, and configuration information of an encoding model.

As an example of the present disclosure, the semantic data may be data extracted from the raw data, and the acquisition unit, the augmentation type and the augmentation ratio may be determined based on share information of the first device and the second device.

As an example of the present disclosure, the update of the share information may be performed by using contrastive learning.

As an example of the present disclosure, acquiring semantic data from raw data and generating augmentation data from the semantic data may further be included.

As an example of the present disclosure, the augmentation data may be generated according to at least one of the augmentation type and the augmentation ratio that are determined based on the share information of the first device and the second device.

As an example of the present disclosure, the update of the share information may be performed by using a transformed signal of the semantic communication signal, and the transformed signal may be generated based on a data format that is used to perform a downstream task.

As an example of the present disclosure, the update of the share information may be performed by using a transform head, and the transform head may include at least one dense layer and at least one non-linear function.

As an example of the present disclosure, the update of the share information may be performed based on at least one result of learning for a downstream task.

As an example of the present disclosure, the learning for the downstream task may be generated based on a first layer of the transform head and at least one layer that is determined to perform the downstream task.

As an example of the present disclosure, the learning for the downstream task may include a fine-tuning operation or a transfer-learning operation.

As an example of the present disclosure, the fine-tuning operation may be performed for every network including a neural network, which is determined according to the downstream task, by using a weight of an encoder, a weight for an additional operation, and a weight for the first layer of the transform head, after pre-training is completed.

As an example of the present disclosure, the transfer-learning operation may be performed for a multi-layer perceptron (MLP), which is added according to the downstream task, in a situation where the weight of the encoder, the weight for the additional operation, and the weight for the first layer of the transform head are fixed, after pre-training is completed.

As an example of the present disclosure, the semantic communication signal may be transmitted in a layer for semantic communication.

### Advantageous Effects

As is apparent from the above description, the embodiments of the present disclosure have the following effects.

In embodiments based on the present disclosure, it is possible to provide a method for transmitting and receiving source and destination signals in semantic communication.

In embodiments based on the present disclosure, it is possible to provide a method for transmitting and receiving a signal between semantic layers located in a source and a destination.

In embodiments based on the present disclosure, it is possible to provide a method for generating a signal suitable for a downstream task of a destination by a source.

In embodiments based on the present disclosure, it is possible to provide a method for performing learning for generating a signal by using contrastive learning.

In embodiments based on the present disclosure, it is possible to provide a learning method for generating a signal suitable for a downstream task of a destination.

In embodiments based on the present disclosure, it is possible to provide a method for updating background knowledge held in a source and a destination to perform a downstream task located at the destination in a task-oriented way.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of artificial intelligence (AI) device applicable to the present disclosure.

FIG. 5 illustrates an example of a communication model divided into 3 stages according to an embodiment of the present disclosure.

FIG. 6 illustrates an example of a semantic communication system according to an embodiment of the present disclosure.

FIG. 7 illustrates an example of contrastive learning according to an embodiment of the present disclosure.

FIG. 8 illustrates an example of instance discrimination for contrastive learning according to an embodiment of the present disclosure.

FIG. 9 illustrates an example of augmentation data according to an embodiment of the present disclosure.

FIG. 10 illustrates an example of a framework for pre-training according to an embodiment of the present disclosure.

FIG. 11 illustrates an example of semantic data generation according to an embodiment of the present disclosure.

FIG. 12 illustrates performance of edge perturbation according to an embodiment of the present disclosure.

FIG. 13 illustrates an example of an additional data transform operation with data modality being graph according to an embodiment of the present disclosure.

FIG. 14 illustrates an example of an additional data transform operation with data modality being text according to an embodiment of the present disclosure.

FIG. 15 is a view exemplifying in-batch training with data modality being text according to an embodiment of the present disclosure.

FIG. 16 illustrates an example of a transform head configuration according to an embodiment of the present disclosure.

FIG. 17 illustrates an example of a framework for training and inference according to a downstream task according to an embodiment of the present disclosure.

FIG. 18 illustrates an example of an operating procedure for generating a semantic signal according to an embodiment of the present disclosure.

FIG. 19 illustrates an example view of an initial setting signal for semantic communication according to an embodiment of the present disclosure.

FIG. 20 illustrates an example view of information exchange in a mini-batch unit according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an” “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. However, the present disclosure is not limited to data transmission and reception between a BS and a mobile station but may be implemented in various forms including data transmission and reception between a mobile station and another mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (IDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release S. In detail, LTE technology after 3GPP TS 36.xxx Release 10 may be referred to as LTE-A, and LTE technology after 3GPP TS 36.xxx Release 13 may be referred to as LIE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

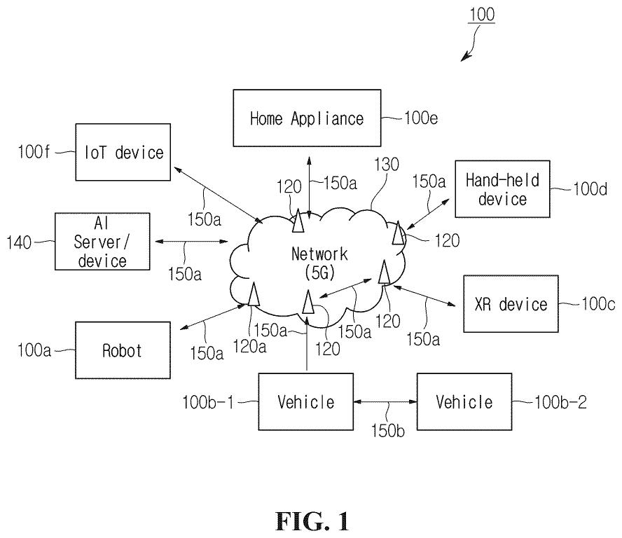

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Communication System Applicable to the Present Disclosure

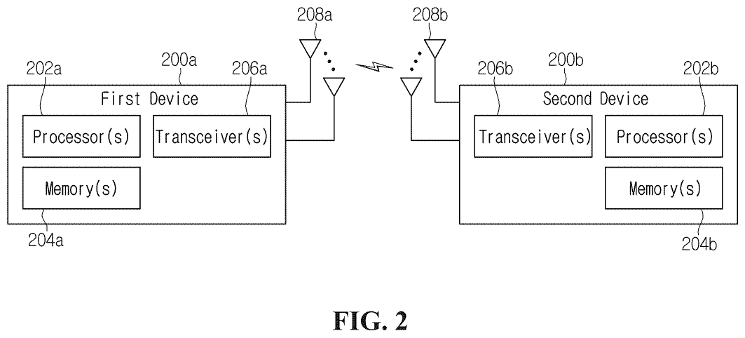

FIG. 2 is a view showing an example of a wireless device applicable to the present disclosure.

Referring to FIG. 2, a first wireless device 200a and a second wireless device 200b may transmit and receive radio signals through various radio access technologies (e.g., LIT or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, soft ware or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

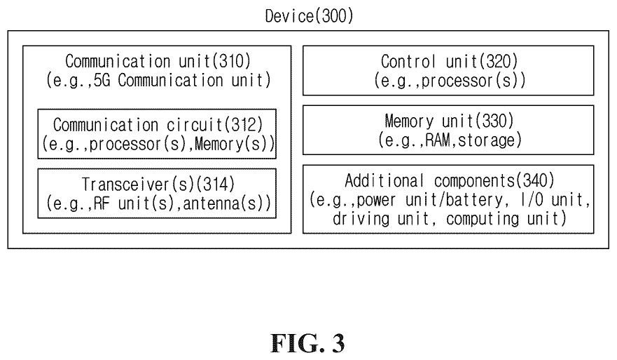

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330, In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/Wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1. 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

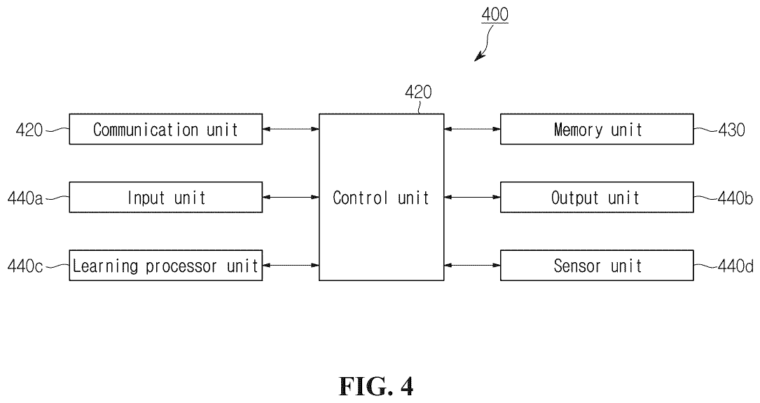

FIG. 4 is a view showing an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 4, the AI device 400 may include a communication unit 410, a control unit 420, a memory unit 430, an input/output unit 440a/440b, a learning processor unit 440c and a sensor unit 440d. Blocks 410 to 430/440A to 440D may correspond to blocks 310 to 330/340 of FIG. 3, respectively.

The communication unit 410 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 410 may transmit information in the memory unit 430 to an external device or send a signal received from an external device to the memory unit 430.

The control unit 420 may determine at least one executable operation of the AT device 400 based on information determined or generated using a data analysis algorithm or machine learning algorithm. In addition, the control unit 420 may control the components of the AI device 400 to perform the determined operation. For example, the control unit 420 may request, search, receive, or utilize the data of the learning processor 440c or the memory unit 430, and control the components of the AI device 400 to perform predicted operation or operation determined to be preferred among at least one executable operation. In addition, the control unit 420 collects history information including a user's feedback on the operation content or operation of the AI device 400, and stores it in the memory unit 430 or the learning processor 440c or transmit it to an external device such as the AI server (140 in FIG. 1). The collected history information may be used to update a learning model.

The memory unit 430 may store data supporting various functions of the AI device 400. For example, the memory unit 430 may store data obtained from the input unit 440a, data obtained from the communication unit 410, output data of the learning processor unit 440c, and data obtained from the sensor unit 440. Also, the memory unit 430 may store control information and/or software code required for operation/execution of the control unit 420.

The input unit 440a may obtain various types of data from the outside of the AI device 400. For example, the input unit 420 may obtain learning data for model learning, input data to which the learning model is applied, etc. The input unit 440a may include a camera, a microphone and/or a user input unit, etc. The output unit 440b may generate audio, video or tactile output. The output unit 440b may include a display unit, a speaker and/or a haptic module. The sensor unit 440 may obtain at least one of internal information of the AI device 400, surrounding environment information of the AI device 400 or user information using various sensors. The sensor unit 440 may include a proximity sensor, an illuminance sensor, an acceleration sensor, a magnetic sensor, a gyro sensor, an inertial sensor, an RGB sensor, an JR sensor, a fingerprint recognition sensor, arm ultrasonic sensor, an optical sensor, a microphone, and/or a radar.

The learning processor unit 440c may train a model composed of an artificial neural network using learning data. The learning processor unit 440c may perform AI processing together with the learning processor unit of the AI server (140 in FIG. 1). The learning processor unit 440c may process information received from an external device through the communication unit 410 and/or information stored in the memory unit 430. In addition, the output value of the learning processor unit 440c may be transmitted to an external device through the communication unit 410 and/or stored in the memory unit 430.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”. “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

The most important and newly introduced technology for the 6G system is AI. AI was not involved in the 4G system. 5C systems will support partial or very limited AI. However, the 6G system will support AT for full automation. Advances in machine learning will create more intelligent networks for real-time communication in 6G Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCIT) AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals, in order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output lay er to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

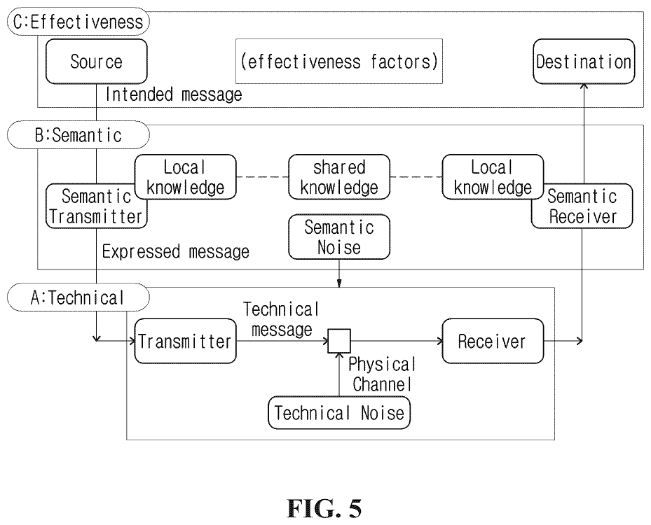

Shannon and Weaver describe communication in three stages. Stage 1 relates to a problem of whether symbols for communication are accurately delivered from technical perspective, Stage 2 relates to a problem of whether the transmitted symbols accurately deliver right meanings from semantic perspective, and Stage 3 relates to a problem of how effectively the received meaning affects a right way of operation from perspective of effectiveness, Thus, FIG. 5 illustrates an example of a communication model divided into 3 stages.

One of the diverse objects of 6G communication is to provide a service capable of interconnecting humans and machines. To this end, semantic communication based on the concept of “meaning conveyance” has been introduced as one of the next-generation wireless communication paradigms. The existing communication puts an emphasis that a receiver (e.g., destination) should decode an encoded signal received from a transmitter (e.g., source) without error. On the other hand, the semantic communication puts an emphasis on a meaning to be conveyed through a signal like human communication in which information is exchanged through the meanings of words.

The core of semantic communication is to extract “meaning” of information delivered from a transmitter. Semantic information may be successfully “interpreted” at a receiver based on a knowledge base (KB) agreed between a source and a destination. Thus, even when there is an error in a signal, if an operation is performed according to a meaning to be delivered through the signal, communication is rightly performed. Accordingly, semantic communication requires an approach to whether a downstream task located in a destination is performed according to an intention contained in a signal (e.g., representation) transmitted from a source. In addition, the destination interprets a meaning (e.g., a purpose of the downstream task) delivered by the source based on background knowledge, which is held in the destination, when performing an inference operation by using the signal delivered from the source. Thus, in order for the destination to perform an operation according to the meaning delivered from the source based on a result from reasoning through the signal delivered from the source, background knowledge included in the signal transmitted from the source should be able to be updated in the background knowledge of the destination. To this end, the transmitted signal should be generated in consideration of the downstream task located at the destination. Such a task-oriented semantic communication system may introduce invariance useful for a downstream task and thus provide a benefit of preserving information relevant to the task.

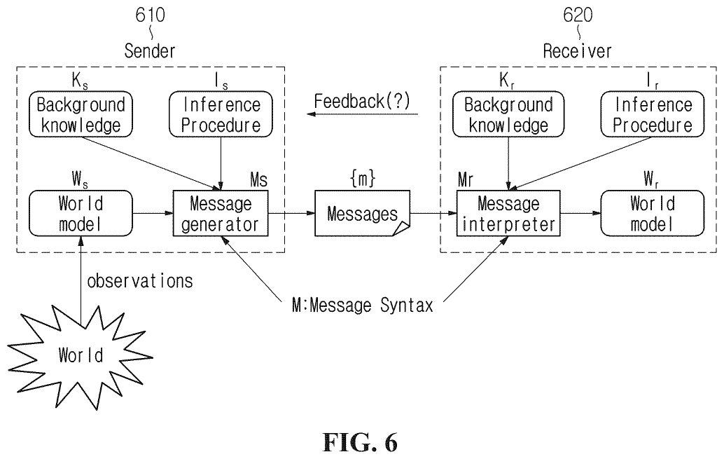

FIG. 6 illustrates an example of a semantic communication system according to an embodiment of the present disclosure.

Referring to FIG. 6, an operation for semantic communication between a transmitter 610 and a receiver 620 may be identified. Shann entropy (W) of a world model w may be expressed as in Equation 1. The Shannon entropy may be model entropy of a semantic source.

$$H ( W ) = - {\sum }_{w ∈ W} μ ( w ) {log}_{2} μ ( w ) \qquad [ Equation 1 ]$$

The world model Wₛ is a set of interpretations with a probability distribution of μ, and is a model distribution. Herein, if Wₓ is a set of models Wₛ with x being true, a logical probability m(x) of a message x may be expressed as in Equation 2.

$$m ( x ) = \frac{μ ( {W}_{x} )}{μ ( W )} = \frac{{\sum }_{w ∈ W , w = x} μ ( w )}{{\sum }_{w ∈ W} μ ( w )} \qquad [ Equation 2 ]$$

Semantic entropy (W) of the message x may be expressed as in Equation 3.

$${H}_{s} ( x ) = - {log}_{2} ( m ( x ) ) \qquad [ Equation 3 ]$$

Herein, when background knowledge k is considered, a set of possible worlds in Equation 2 and Equation 3 may be limited to a set compatible with k. Accordingly, it may be expressed by a conditional logical probability as in Equation 4 and Equation 5.

$$m ( x \vert K ) = \frac{μ ( {W}_{x} )}{μ ( W )} = \frac{{\sum }_{w ∈ W , w = K , x} μ ( w )}{{\sum }_{w ∈ W , w = K} μ ( w )} \qquad [ Equation 4 ]$$

$${H}_{s} ( x \vert K ) = - {log}_{2} ( m ( x \vert K ) ) \qquad [ Equation 5 ]$$

As an example, Table 2 below exemplifies a truth table with p being statistical probabilities and k being background knowledge. Specifically, Table 2 is an example of a truth table with p(A) p(B)=0.5 and K={A->B}.

TABLE 2

| # | A | B | A → B | probability |
|---|---|---|---|---|
| 1 | 0 | 0 | 1 | 0.25 |
| 2 | 0 | 1 | 1 | 0.25 |
| 3 | 1 | 0 | 0 | 0.25 |
| 4 | 1 | 1 | 1 | 0.25 |

According to Table 2, possible worlds may be reduced to a series of truth assignments with A->B being true (e.g., 1, 2, 4 in Table 1). Accordingly, conditional logical probabilities as shown in Equation 6, Equation 7 and Equation 8 may be obtained.

$$m ( A \vert K ) = 1 / 3 \qquad [ Equation 6 ]$$

$$m ( B \vert K ) = 2 / 3 \qquad [ Equation 7 ]$$

$$m ( A ∧ B ) = 1 / 3 \qquad [ Equation 8 ]$$

Because logical probabilities are based on background knowledge, the logical probabilities are different from priori statistical probabilities, and A and B in a new distribution are not logically independent any more (^{as m(A|K)m(B|K)≈m(AB|K)}).

Meanwhile, when background knowledge k exists, the new distribution μ′ of a model set may be expressed as in Equation 9 and Equation 10.

$${μ}^{′} = \frac{μ ( w )}{{\sum }_{w ∈ W , v = K} μ ( v )} \qquad [ Equation 9 ]$$

$$H ( W \vert K ) = {\sum }_{w ∈ W , w = K} {μ}^{′} ( w ) {log}_{2} ( {μ}^{′} ( w ) ) \qquad [ Equation 10 ]$$

Equation 11 below represents entropy of a source that does not consider background knowledge, and Equation 12 below represents model entropy of a source that considers background knowledge.

$$H ( W ) = - 4 * 0.25 {log}_{2} ( 0.25 ) = 2 \qquad [ Equation 11 ]$$

$$H ( W \vert K ) = - 3 * 1 / 3 {log}_{2} ( 1 / 3 ) = 1.585 \qquad [ Equation 12 ]$$

As shown in Equation 11 and Equation 12, a source may compress a message to be delivered without missing information through shared background knowledge. That is, a source and a destination may transmit and receive as much information as possible in a small data volume through shared background knowledge. One of the main reasons for the improved performance of semantic-level communication as compared to the existing technical level is that background knowledge is considered. Accordingly, the present disclosure proposes a method for generating and transmitting/receiving a signal by considering background knowledge suitable for a downstream task at a destination.

According to an embodiment of the present disclosure, a semantic layer may be added as a new layer for managing an overall operation for semantic data and messages. As a layer for a task-oriented semantic communication system, the semantic layer may be used to generate and transmit/receive a signal between a source and a destination. In order to perform communication through the semantic layer, a protocol, which refers to rules among layers, and a definition for a series of operating processes may be required, which will be described below.

Meanwhile, in a real communication environment, raw data held or collected by a source are mostly data that have not been subject to labeling (hereinafter, unlabeled data). Herein, if labeling is performed for unlabeled data, an extra cost may occur. Accordingly, for a technology of performing communication using unlabeled data, contrastive learning, which is an artificial intelligence (AI)/machine learning (ML) technology, may be used. Hereinafter contrastive learning will be described as a technology applicable to a semantic system. As an example, contrastive learning may be introduced into a semantic layer for performing semantic communication.

Contrastive learning is a method of correlation of data through a representation space. Specifically, through contrastive learning, high-dimensional data may be changed to low-dimensional data (e.g., dimension reduction) and be located in a representation space. Then, a similarity between data may be measured based on location information of each data located in the representation space. As an example, through contrastive learning, a semantic communication system may be trained to locate representations of a positive pair close to each other and to locate representations of a negative pair far away from each other. A positive pair is a pair of similar data, and a negative pair is a pair of non-similar data. Contrastive learning is applicable both to supervised learning and unsupervised learning but may be especially useful for learning using unsupervised-data without labeling data. Accordingly, contrastive learning is suitable for setting up a task-oriented semantic communication system in the real environment occupied mostly by unlabeled data.

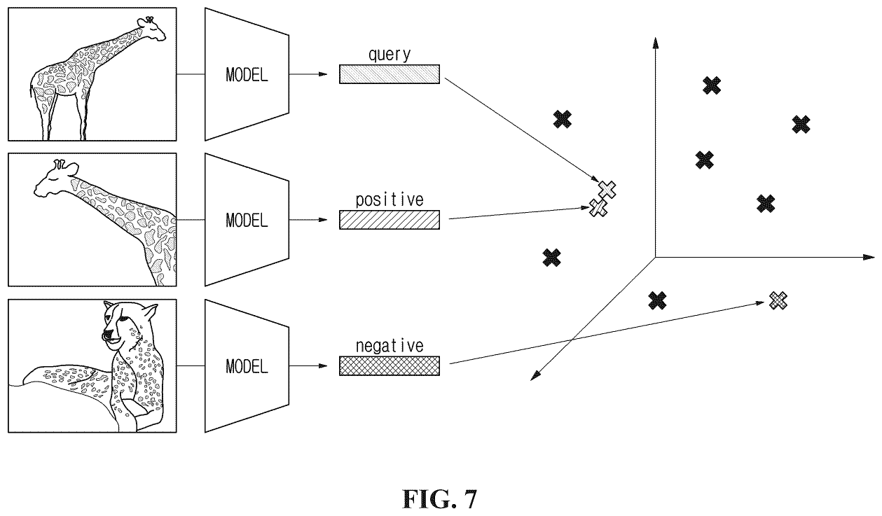

FIG. 7 illustrates an example of contrastive learning according to an embodiment of the present disclosure.

As an example, FIG. 7 illustrates a case in which contrastive learning is performed based on giraffe images. However, this is merely one example for convenience of explanation, and the present disclosure may not be limited to the above-described embodiment. Referring to FIG. 7, it may be shown that contrastive learning performed herein has a classification task as its target task and images as its data modality. A reference query for performing the classification task of image data is a giraffe image. Representations of giraffe images may be learned to be located close to the representation of the query, and representations of non-giraffe images may be learned to be located far away from the representation of the query. That is, contrastive learning trains an encoder so that similar data to reference data can be mapped in close locations and non-similar data to the reference data can be mapped in distant locations.

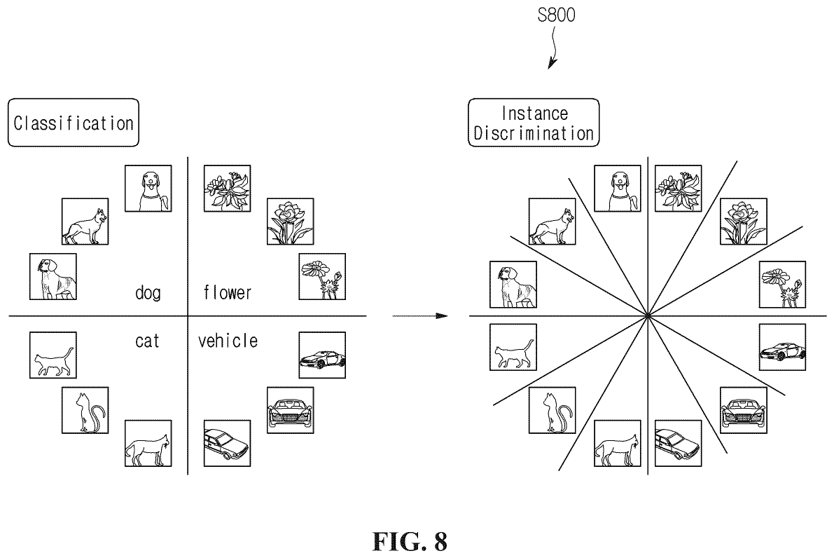

FIG. 8 illustrates an example of instance discrimination 700 for contrastive learning according to an embodiment of the present disclosure. A model performing contrastive learning may learn data through the instance discrimination 700.

An instance means each data sample to be trained. As an example, an instance may be a sample of image data with a specific size or a text data sample in a sentence unit. Instance discrimination performs classification of data by determining every instance in an overall data set by each class. Accordingly, when there are N instances, discrimination may be performed N times. As instance discrimination enables a distance between instances to be learned based on a similarity between the instances, it provides a benefit of obtaining a useful representation for data without labeling information. When a downstream task is performed using a representation learned through instance discrimination, the performance of a model may be improved to the level of supervised learning.

Meanwhile, when the number of data samples increases, an amount of work for instance discrimination increases significantly. As an example, when there are 10 million data samples, the discrimination work may be performed 10 million times. Accordingly, as the number of data samples increases, a denominator for softmax calculation for calculating a probability increases, and a probability value decreases, so that learning may become difficult. To solve this problem, noise-contrastive estimation (NCE) may be used as an appropriate method for calculating an approximation. A multi-class classification operation may be changed to a binary classification operation that determines whether a sample is a data sample or a noise sample through NCE

In order to perform NCE, a comparison method needs to be defined to determine whether any sample is a similar sample (hereinafter, positive sample) or a non-similar sample (hereinafter, negative sample). One method for generating a positive sample is data augmentation (hereinafter, augmentation). Augmentation refers to generating new data by modifying existing data. From the semantic perspective, augmentation data contains the same meaning as a meaning that existing data wants to deliver. That is, the existing data and the augmentation data contain the same information. Accordingly, respective representations of the existing data and the augmentation data should be similar. Accordingly, an existing image and augmentation data may be defined as positive samples, and non-positive samples may all be defined as negative samples.

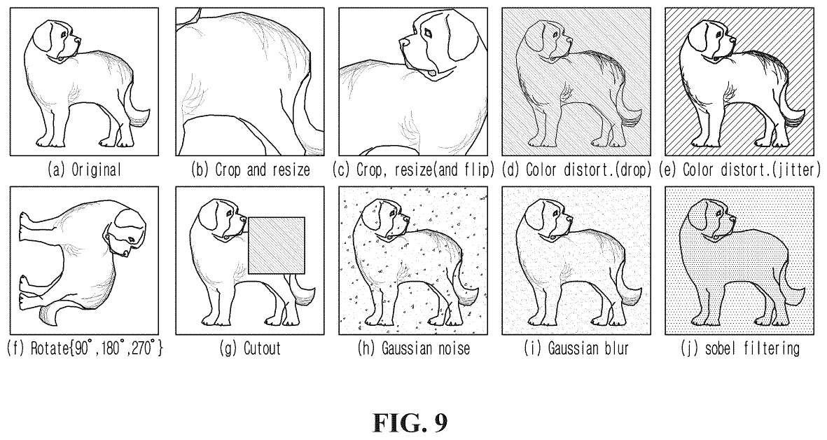

FIG. 9 illustrates an example of augmentation data according to an embodiment of the present disclosure.

Referring to FIG. 9, a result of augmentation performed for a dog image may be seen. As an example, data may be augmented through a method of cropping a part of data, a method of resizing data, a method of flipping data, a method of changing color, and a method of rotating data.

For contrastive learning, the NCE loss function of Equation 13 may be used.

$$ℒ = {𝔼}_{x , {x}^{+} , {x}^{-}} [ - log ( \frac{{e}^{{f ( x )}^{T} f ( {x}^{+} )}}{{e}^{{f ( x )}^{T} f ( {x}^{+} )} + {e}^{{f ( x )}^{T} f ( {x}^{-} )}} ) ] \qquad [ Equation 13 ]$$

In Equation 13, x is data that becomes a criterion (query data), x⁺ is data related to query data or data similar to x, and x⁻ is data not related to query data or data not similar to x.

As described above, a contrastive learning technique provides a benefit of learning a useful representation from unlabeled data themselves. Accordingly, the contrastive learning technique may be integrated into semantic communication as the AI/ML technology of an encoder that performs semantic source coding. Additionally, background knowledge held by a source and a destination should be adequately utilized so that representations based on an embedding space may be generated from data. In addition, information of positive samples and negative samples, which a model learns, needs to be updated in the background knowledge of the source and the background knowledge of the destination.

Thus, a framework proposed by the present disclosure may include a pre-training operation for semantic source coding and a training operation for a downstream task of a destination. Herein, the semantic source coding is an operation of generating a signal (e.g., representation) that the source will transmit to the destination. Through the present disclosure, a transmission/reception signal may be generated by considering a downstream task to be performed at a destination, and the downstream task may be performed according to an intention delivered by a source. When pre-training and training for a downstream task are completed, inference may be performed.

Meanwhile, the present disclosure may be applied to a signal transmission/reception protocol using a semantic layer, which may be newly added, but is not limited thereto and may be applied to a framework for task-oriented semantic communication using contrastive learning and a relevant procedure.

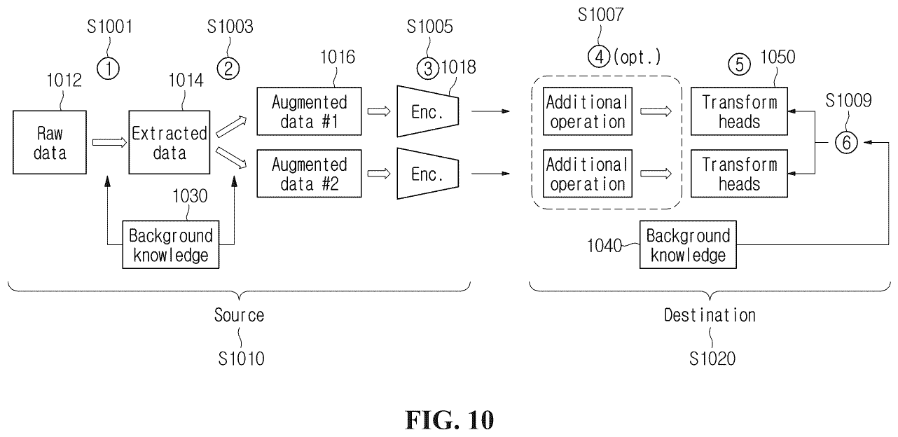

FIG. 10 illustrates an example of a framework for pre-training according to an embodiment of the present disclosure. A framework for pre-training may consist of operations of a source 1010 and a destination 1020. Herein, a transform head 1050 may be used as one of encoding models. Steps S1001 to S1005 described below are operations performed in the source, and steps S1007 and S1009 are operations performed in the destination. Herein, pre-training may be performed in a mini-batch unit.

Referring to FIG. 10, at step S1001, the source 1010 may acquire semantic data 1014 from raw data 1012. The semantic data 1014 is data extracted from the raw data 1012. The semantic data 1014 may be used to generate a message (e.g., representation) including ‘meaning’ information to be delivered from the source 1010 to the destination 1020. Herein, an acquisition unit of the semantic data 1014 may be determined by using background knowledge 1030 and 1040 held by the source 1010 and the destination 1020.

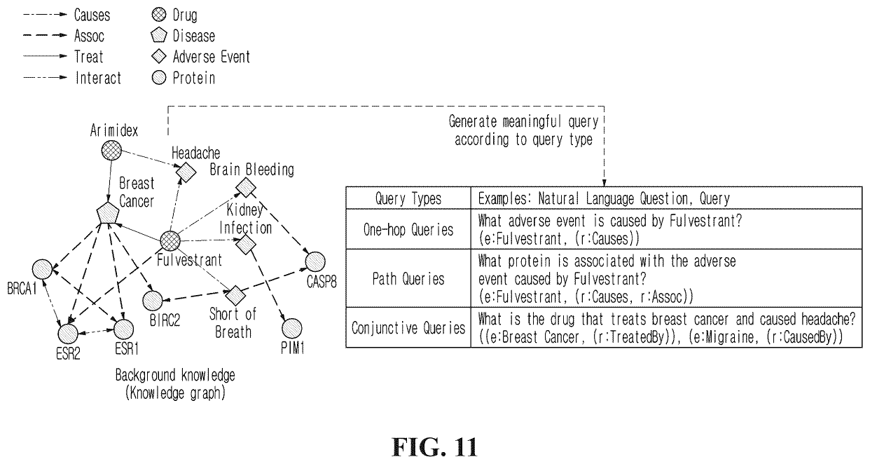

As an example, as shown in FIG. 11, when background knowledge includes a biomedicine knowledge graph and a source acquires semantic data with a query type from raw data, semantic data acquisition units such as a query related to a corresponding biomedicine field ‘a type of the query’, and ‘a length of the query’ may be determined based on the biomedicine knowledge graph. As another example, when a source acquires semantic data with a text type from raw data, semantic data acquisition units such as whether to transmit data in a sentence unit or a paragraph unit may be determined based on background knowledge related to text data.

At step S1003, the source 1010 may perform augmentation for the semantic data 1014. Augmentation may be used to increase a total number of population parameters of data by generating new data through modification of data. As an example, the source 1010 may augment the semantic data 1014 to generate a positive sample necessary for contrastive learning. Herein, if semantic data thus acquired are N mini-batches, 2N augmentation data may be generated.

An augmentation type may be different according to modality of data. Table 3 below exemplifies an augmentation type when data modality is image.

TABLE 3

| Category | Type |
|---|---|
| Geometric | Transformations using flipping, cropping, |
| Transformations | rotation, color space, noise injection and the like |
| Color space | Luminous intensity is adjusted by controlling |
| Transformation | one of R, G and B values to a minimum |
| | value or a maximum value. |
| Kernel Filter | Pixels of a region are randomly mixed in a |
| | size of N × N by using a Gaussian filter, an |
| | edge filter, a patch shuffle filter and the like. |
| Random Erasing | A specific portion of an image is randomly |
| | deleted to generate a new image. |
| Mixing Images | A new image is generated by using respective |
| | portions from a plurality of images. |

Table 4 below exemplifies an augmentation technique when data modality is text.

TABLE 4

| Category | Sub-category | Type |
|---|---|---|
| Text | Random Noise | Synonym Replace(SR), Random |
| modification | Injection | Insertion(RI), Random Swap(RS), |
| | | Random Depletion(RD) |
| Text | Back-Translation | Artificial data are generated from |
| generation | | monolingual data by using a translator. |
| | | Beam Search, Random Sampling, |
| | | Top-10 Sampling, Beam + Noise |
| | Conditional Pre- | Fine-tuning is performed for a text by |
| | training using a | augmentation pre-trained model and |
| | pre-trained model | including label information through 3 |
| | | pre-trained models (Auto- |
| | | Regressive(AR), Auto-Encoder(AE), |
| | | Sequence-to-sequence(Seq2Seq)). |
| Other | Dropout noise | Based on a same sentence, a positive |
| | | pair with similar embedding is |
| | | generated by changing only a |
| | | dropout mask. |

Table 5 below exemplifies an augmentation technique when data modality is graph.

TABLE 5

| Category | Sub-category | Type |
|---|---|---|
| Topology | Edge perturbation | Edge Removing(ER), Edge |
| (structure) | | Adding(EA), Edge Flipping(EF) |
| augmentation | Node perturbation | Node Dropping(ND) |
| | Subgraph | Subgraph induced by Random |
| | sampling(SS) | Walks(RWS) |
| | Graph | Diffusion with Personalized |
| | Diffusion(GD) | PageRank(PPR), Diffusion with |
| | | Markov Diffusion Kernels[MDK] |
| Feature | | Feature Masking[FM], Feature |
| augmentation | | Dropout[FD] |

Meanwhile, a type of application augmentation may affect the performance of semantic source coding of an encoder 1018. As an example, when the modality of data transmitted by the source 1010 is a text and a downstream task located at a destination is to distinguish between a positive sentence and a negative sentence, a grammatical element of the text may cause an operation not to be performed as intended by a meaning from the source 1010. Accordingly, in order to preserve a meaning to be delivered through text data, a type of augmentation and a ratio of augmentation should be set based on the background knowledge 1030.

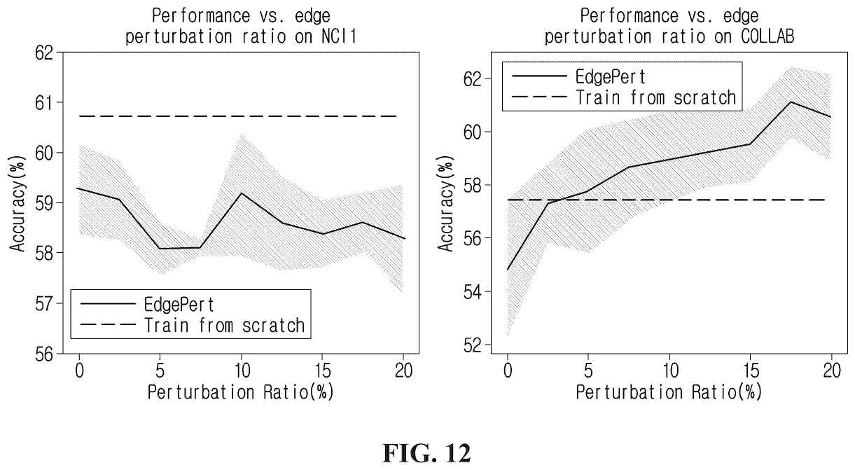

Referring to FIG. 12, in comparison with COLLAB that is social network data, the performance of edge perturbation for NCI1, which is biochemical molecules data related to chemical substances, has been degraded. This indicates that a change of edge in biomolecule data like NCI1 corresponds to deletion or addition of a covalent bond, the identity and validity of a compound may be greatly modified, and a meaning to be delivered by the source 1010 to the destination 1020 may not be rightly delivered. Accordingly, in order not to perform augmentation like edge perturbation on data like NCI1, the source 1010 or the destination 1020 may set a data augmentation type by using the background knowledge 1030. In addition, through FIG. 12, it may be seen that performance is determined according to a perturbation ratio. Accordingly, an application ratio of data augmentation needs to be set also by using the background knowledge 1030.

Meanwhile, in order to improve system performance, the source 1010 may generate augmentation data 1016 by combining a plurality of augmentation techniques. As an example, when data modality is image, the source 1010 may augment data by combining all the 4 augmentation techniques of crop, flip, color jitter and grayscale. In addition, the source 1010 may augment data by using a plurality of augmentation techniques that belong to different categories. Actually, in comparison with applying an augmentation included in a single category, when data modality is graph, the performance of a system is improved when a plurality of augmentation techniques included in a plurality of categories are used to generate a similar sample. In addition, a combination of augmentation techniques showing optimal performance is different according to a domain of data. That is, the augmentation type and ratio should be set based on the background knowledge 1030 (e.g., domain knowledge) that is held, according to data modality.

At step S1005, the source 1010 may perform encoding on the augmentation data 1016. Herein, the suitable encoder 1018 may be used according to data modality. As an example, when data modality is image, a CNN-based model (e.g., ResNet18) may be used, and when data modality is text, a pre-trained model (e.g., BERT) may be used. As an example, the encoder 1018 located in each dual-branch may be identical. In addition, when the encoder 1018 uses an existing model, a configuration for feature extraction alone may be used among configurations of the encoder 1018. Herein, the configuration for feature extraction may be used to acquire a representation. The source 1010 transmits a result generated by performing encoding (hereinafter, ‘encoding data’) to the destination 1020. Herein, the encoding data may be a semantic message that is made using semantic data in semantic communication.

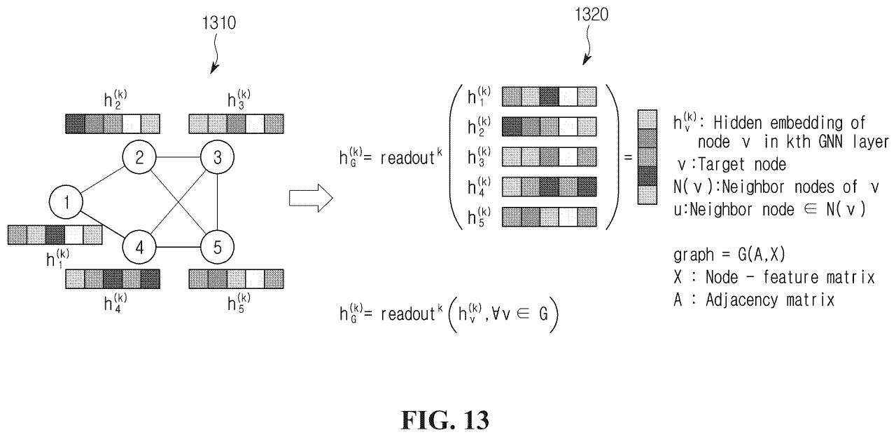

Meanwhile, at step S1007, the destination 1020 may perform an additional operation for transforming a format of the encoding data according to a format of data used for performing a downstream task. FIG. 13 illustrates an example of an additional data transform operation with data modality being graph according to an embodiment of the present disclosure. Referring to FIG. 13, when encoding is performed on data, an output may be produced as a node representation 1210. Herein, a destination (e.g., the destination 1020 of FIG. 10) may determine whether to perform an additional operation according to an operation method of a downstream task. If the downstream task is an operation that is performed using the node representation 1210, the destination may not perform the additional operation. On the other hand, if the downstream task is an operation that is performed using a graph representation, the destination may perform an addition operation that transforms a node representation to a graph representation. Herein, the destination may perform the additional operation through a configured readout function 1220 (e.g., average, sum, etc.).

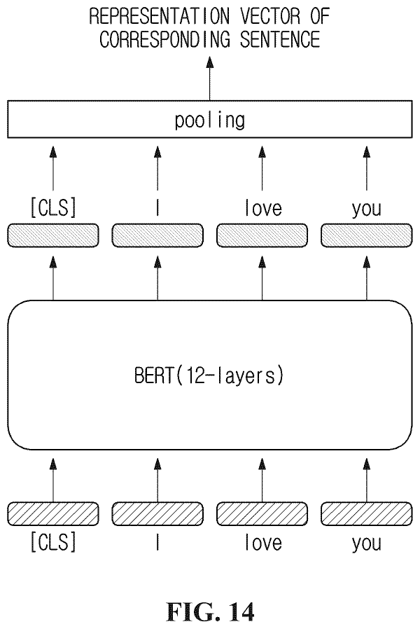

As another example, FIG. 14 illustrates an example of an additional data transform operation with data modality being text according to an embodiment of the present disclosure. Referring to FIG. 14, text data may be encoded through a pre-trained model (e.g. BERT). In addition, as an encoding result, a work vector set, which is a representation in a word unit, may be output. A destination may determine whether to perform an additional operation according to an operation method of a downstream task. If the downstream task is an operation that is performed using a word representation, the destination may not perform the additional operation. On the other hand, if the downstream task is an operation that is performed using a context vector that is a context-based representation, the destination may transform a word vector to a context vector by using a pooling operation (e.g., mean, max, etc.).

As another example, when data modality is image, local feature vectors as encoding results may be output from each branch, and a destination may, perform an additional operation for generating a global summary vector from one of the paths. Herein, a model may generate a global summary vector in a similar method that uses a readout function when data modality is graph.

As shown in the above-described embodiments, task-oriented semantic communication may be performed by an additional operation that is performed to acquire a representation suitable for a purpose of a downstream task located in a destination. Thus, flexibility may be given to a semantic communication system. Herein, additional operations of step S1007 may be learned by being configured as a multi-layer perceptron (MLP).

When step S1007 is completed, the destination 1020 may learn encoding data by using a loss function at step S1020. Hereinafter, the transform head 1050 used for learning will be described.

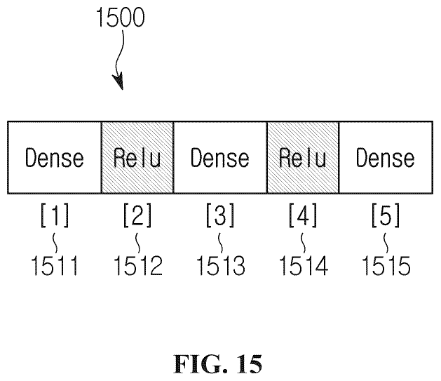

FIG. 15 illustrates an example of a configuration of a transform head 1500 according to an embodiment of the present disclosure. The transform head 1500 is an example of an encoder (e.g., the transform head 1050 of FIG. 10) for a semantic communication system.

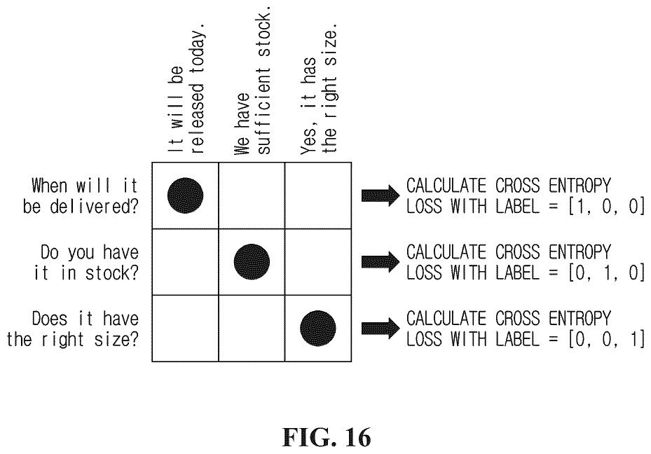

Referring to FIG. 15, through a projection head technique, the transform head 1500 may include rectified linear units (ReLu) 1512 and 1514 corresponding to at least one dense layers 1511, 1513 and 1515 and at least one non-linear function. The structure of the transform head 1500 is not limited to the structure of FIG. 15, and the number of layers and the non-linear function may be different according to the model of an encoder. The transform head 1500 is configured as shown in FIG. 16 for the following reason.

A SimCLR-based model calculates a loss by using a non-linear projection head. In this case, performance is better than when using a linear projection head or not using a projection head. In addition, a SimCLRv2-based model performs training by increasing a size of an encoder model and increasing the number of linear layers constituting a projection head. It is because performance is improved as a label fraction is lower and the number of layers of a projection head is larger. Thus, the present disclosure proposes a transform head configured as exemplified in FIG. 16 as an encoding model for maximizing the performance of semantic communication through effective embedding learning.

Next, at step S1009, the destination 1020 may learn encoding data (e.g., representation) by using a loss function Herein, the learning imay be performed by using InfoNCE loss. The InfoNCE loss may be expressed as in Equation 14 below

$${𝒥}_{InfoNCE} ( {v}_{i} ) = - \frac{1}{P} {\sum }_{{p}_{j} ∈ 𝒫 ( {v}_{i} )} log \frac{{e}^{θ ( {v}_{i} , {p}_{j} ) / τ}}{{e}^{θ ( {v}_{i} , {p}_{j} ) / τ} + {\sum }_{{q}_{j} ∈ 𝒬 ( {v}_{i} )} {e}^{θ ( {v}_{i} , {q}_{j} ) / τ}} \qquad [ Equation 14 ]$$

Equation 14 is obtained by adding a temperature parameter τ, which is an element adjustable through a penalty on a hard negative sample, to Equation 1. In Equation 15, vᵢ is an original sample corresponding to a query, pⱼ is a positive sample, and qⱼ is a negative sample. θ(′, ′) is a function for comparing a similarity between embeddings. As an example, the cosine similarity of Equation 15 below may be used. In Equation 15, g(′, ′) may be configured as a MLP.

$$θ ( u , v ) = \frac{{g ( u )}^{T} g ( v )}{‖ g ( u ) ‖ ‖ g ( v ) ‖} \qquad [ Equation 15 ]$$

Meanwhile, because learning is also performed in a mini-batch unit, negative samples may be considered within a batch. Referring to FIG. 16, in case a batch has a size of 3, 3 diagonal components that are similar data pairs (e.g., positive pairs) may be confirmed. Herein, a similar data pair may be a pair of a question and an answer to the question. Similar data pairs may become data pairs that are not similar to each other within a batch (e.g., negative pairs). Herein, a non-similar data pair may be a pair of a question and a wrong answer to the question, That is, for each similar data pair, ‘a batch size—1’ non-similar relations may be considered. In addition, a method of generating a negative sample used for learning has a great effect on learning performance. A hard negative sample is a sample that is similar sample but is predicted as non-similar data. The performance of a semantic communication system may be improved by learning a hard negative sample, which a destination extracts using background knowledge, together with delivered samples.

In addition, for learning, a semantic communication system may use a negative sample stored in a memory when performing negative sampling by introducing a memory network (e.g. a moving average of weight for stabilization) buffering a negative pair to a destination. An operation of buffering a negative pair in a batch unit may correspond to an operation of updating background knowledge held in a destination in semantic communication. Thus, background knowledge included in data delivered from a source may be reflected in the background knowledge of the destination, so that the source and the destination may share their background knowledge.

In addition, the semantic communication system may buffer a sample corresponding to a positive pair delivered in a mini-batch unit in the memory network. A sample corresponding to a positive pair (hereinafter, ‘positive pair sample’) may be managed together with a sample corresponding to a negative pair (hereinafter, ‘negative pair sample’). Herein, positive pair samples and negative pair samples may be a unit of background knowledge. In addition, a memory network buffering samples may constitute background knowledge. As a source may generate a sample in a mini-batch unit based on background knowledge held in it, samples thus generated may include information on the background knowledge held by the source. Accordingly, a destination may update background knowledge held in it based on information on samples in the mini-batch unit received from the source. Thus, the source and the destination may share their background knowledge.

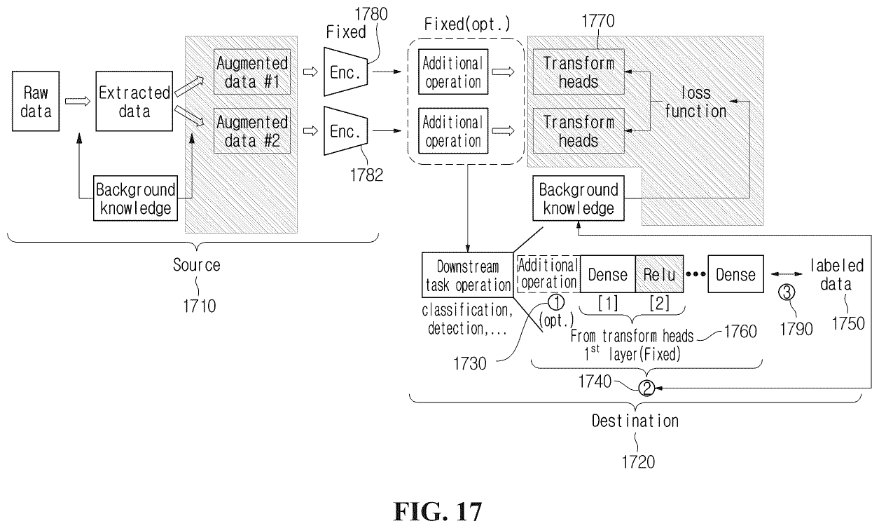

When the pre-training described in FIG. 10 is completed, training may be performed to perform a downstream task at a destination, and when the training is completed, inference may be performed. Herein, the destination is assumed to hold some of labeled data. FIG. 17 illustrates an example of a framework for training and inference according to a downstream task according to an embodiment of the present disclosure. In FIG. 17, the shaded part may not be used in the training and inference operations according to a downstream task.

Referring to FIG. 17, a destination 1720 performs training for an operation of a downstream task (hereinafter, ‘training for the downstream task’) located at the destination 1720. As an example, the destination 1720 may determine layers 1740 used for performing the training for the downstream task (hereinafter, ‘downstream task training layers’) (e.g., MLP) The downstream task training layers 1740 may include a first layer 1760 of a transform layer (e.g., the transform head 1050 of FIG. 10, the transform head 1770 of FIG. 17) used for pre-training (e.g., the pre-training operation of FIG. 10) and additional linear layers. Herein, the first layer 1760 of the transform head 1770 may be fixed and not modified, and the additional linear layers may be determined suitably for a purpose (e.g., classification, detection, etc.) of the downstream task performed at the destination.

Meanwhile, according to the number of paths used for the training for the downstream task, one or two encoding results 1780 and 1782 may be transmitted to the destination 1720. When the two encoding results 1780 and 1782 are delivered to the destination 1720, an additional operation 1730 described below may be performed.

As an example, both the encoding results 1780 and 1782 in two paths are used for the training for the downstream task, the source 1710 may transmit the two encoding results 1780 and 1782 to the destination 1720 by using all the two paths. The destination 1720, which receive the two encoding results 1780 and 1782, may perform an operation of transforming the two encoding results 1780 and 1782 into one result through the additional operation 1730. Herein, one of various functions such as sum, average and concatenation may be used. The operation may be trained through an MLP As another example, when only one path is used for training for a downstream task, the source 1710 may transmit one encoding result 1780 or 1782, which is obtained by selecting only one path, to the destination. Herein, the destination 1720 may not perform the additional operation 1730.

When the downstream task training layers are determined, the destination 1720 may learn a representation delivered from the source 1710 by using the downstream task training layers 1740, Herein, the destination 1720 may perform reasoning of an output suitable for an intention delivered from the source 1710 by utilizing the background knowledge of the destination 1720 that has been updated in the pre-training process.

Meanwhile, the destination 1720 of FIG. 17 may perform training by using a loss function. The destination 1720 may perform training by using labeled data 1750 and an output from the downstream task training layers 1740. As an example, the training may be performed by using a cross entropy loss. Herein, the cross entropy loss is merely one example of a loss function used for training and is not limited thereto, and another loss function (e.g., cosine similarity loss, hinge loss, etc.) may be used for training. Training using a loss function may be performed according to a purpose of a downstream task located at a destination.

According to an embodiment, in case the destination 1720 performs fine-tuning after pre-training is completed, the destination 1720 may perform training for every network including a neural network consisting of the downstream task training layers 1740 by using a weight of the encoders 1780 and 1782 located at the source 1710 and a weight for the additional operation of the destination 1720.

According to another embodiment, after pre-training is completed, in case the destination 1720 performs transfer-learning, the destination 1720 may fix a weight of the encoders 1780 and 1782 located at the source 1710, a weight for the additional operation of the destination 1720 and a weight corresponding to a first layer of the transform head 1770 and perform learning for a neural network that is added to be suitable for a purpose of a downstream task.

Herein, fixing the weight of the encoders 1780 and 1782, the weight for the additional operation of the destination 1720 and the weight corresponding to the first layer of the transform head 1770 may mean fixing a feature extractor. If the downstream task training layers 1740 exclude a portion with a fixed weight and include only simple linear layers, the performance of the feature extractor may be checked because the performance of the feature extractor needs to be improved to improve performance through training.

Thus, training for a downstream task may be performed by learning related networks according to a purpose of the downstream task. Meanwhile, when pre-training and training for a downstream task are completed in a semantic communication system, inference may be performed for an entire network where every training is completed. Herein, inference may mean a reasoning operation of the destination 1740 for an intention delivered from the source 1710 in task-oriented semantic communication. Accordingly, an output produced through the downstream task training layers 1740 of FIG. 17 may be deemed an inference result. A training result for a downstream task may be delivered to the source 1710 and be used to update the source 1710 on the background knowledge of the destination 1720.

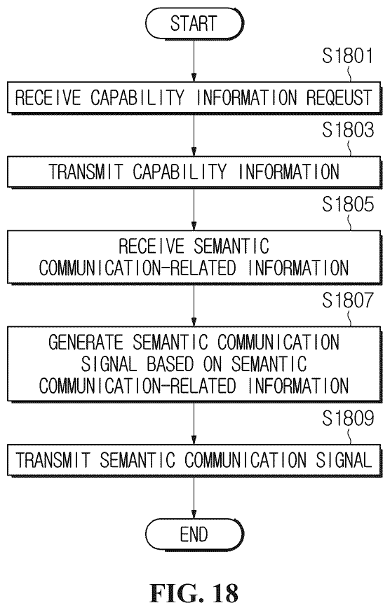

FIG. 18 illustrates an example of an operating procedure for generating a semantic signal according to an embodiment of the present disclosure.

Referring to FIG. 18, at step S1801, a first device receives a capability information request for the first device from a second device. At step S1803, the first device transmits capability information to the second device. Herein, the capability information is used to determine whether the first device is capable of performing semantic communication. As an example, the capability information may include a type of raw data, which the first device may collect, generate or process, and operation capability information of the first device.

At step S1805, in case, based on the capability information of the first device, the first device is determined to have semantic communication capability, the first device receives semantic communication-related information from the second device. The semantic communication-related information may be used to generate a semantic communication signal by performing semantic source coding. The semantic communication signal may be a representation including a meaning that the first device wants to deliver to the second device. The semantic communication signal may be used by the second device to perform a downstream task without being decoded to raw data that the first device uses to generate the representation. The semantic communication-related information and the semantic communication signal may be used to update shared information (e.g., background knowledge) held by the first device and the second device.

As an example, the semantic communication-related information may include at least one of a pre-training result for semantic source coding, a training result for a downstream task, and an inference result, Pre-training, training for a downstream task, or inference may be performed by the first device and the second device. As another example, the semantic communication-related information may include at least one of a unit of data to be acquired from raw data, a mini-batch size, an augmentation type and proportion determined based on background knowledge, or information on an encoding model. Later, the semantic communication-related information may be updated based on a pre-training result, a training result for a downstream task, and an inference result.

At step S1807, the first device may generate a semantic communication signal based on the semantic communication-related information. At step S1809, the first device may transmit the generated semantic communication signal to the second device. The second device may perform a downstream task by using the semantic communication signal without a procedure of decoding the signal. In addition, the second device may acquire background knowledge information of the first device based on the semantic communication signal and update background knowledge held by the second device.

In FIG. 18, a procedure of generating a semantic signal is described through an operation between a first device and a second device, but this is merely an example for convenience of description, and the present disclosure may not be limited to the above-described embodiment. That is, the procedure may also be used in various embodiments such as an operation between a terminal and a base station, an operation between a terminal and another terminal (e.g., D2D communication) and the like.

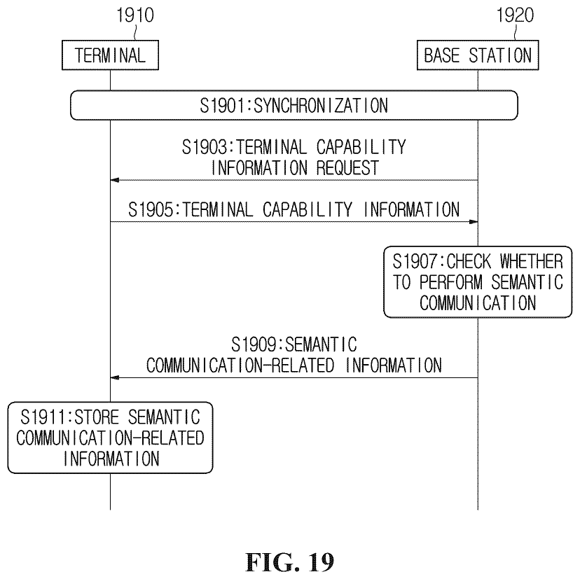

FIG. 19 illustrates an example view of an initial setting signal for semantic communication according to an embodiment of the present disclosure.

Referring to FIG. 19, at step S1901, a device and a base station may perform synchronization. As an example, the device may receive a synchronization signal block (SSB) including a master information block (MIB). The device may perform initial access based on the SSB.

At step S1903, the base station may request terminal capability information to the device. At step S1905, the device may transmit the terminal capability information to the base station. The terminal capability information is information regarding whether the terminal is capable of performing semantic communication. The base station may request the terminal capability information to the terminal in order to check whether semantic communication is to be performed. The terminal capability information may include a type of raw data, which the terminal is capable of generating, collecting or processing, and information on operation capability of the device.

At step S1907, the base station may determine, based on the terminal capability information, whether the terminal is capable of performing semantic communication. Steps S1909 and S1911 below may be performed when the base station determines, based on the terminal capability information, that the terminal is capable of performing semantic communication.

At step S1909, the base station may transmit semantic communication-related information to the device. At step S1911, the device may store the semantic communication-related information. The semantic communication-related information may include an acquisition unit of semantic data, a mini-batch size, an augmentation type according to domain knowledge, an augmentation ratio, and information on an encoder model. As an example, the semantic communication-related information may be transmitted by being included in at least one of DCI, media access control (MAC) or radio resource control (RRC) message.

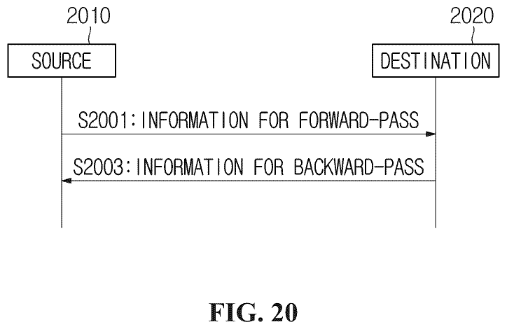

FIG. 20 illustrates an example view of information exchange in a mini-batch unit according to an embodiment of the present disclosure. If the number of mini batches is set to N, the number of augmentation datasets generated at a source may be 2N. An encoder of the source may generate 2N representations by encoding the 2N augmentation datasets. Then, the source may transmit the generated 2N representations to a destination.

Referring to FIG. 20, at step S2001, the source may transmit information for forward-pass to the destination. The information for forward-pass may include a representation result that is a result of encoding for augmentation data.

At step S2003, the destination may transmit information for backward-pass. The information for backward-pass may include gradient information used for training.

Some of the steps described in FIG. 19 and FIG. 20 may be omitted depending on a situation or a setting.

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

1-20. (canceled)

21. A method comprising:
receiving a synchronization signal block (SSB);
performing synchronization based on the SSB;
performing initial access based on the SSB;
receiving a capability information request for a first device from a second device;
transmitting capability information of the first device to the second device;
in case that the first device being a device equipped with a semantic communication capability based on the capability information of the first device, receiving semantic communication-related information from the second device;
generating a semantic communication signal based on the semantic communication-related information; and
transmitting the semantic communication signal which is related to share information to the second device,
wherein the share information is updated based on an operation of a downstream task performed in the second device.

22. The method of claim 21, wherein the semantic communication signal is used by the second device to perform the downstream task without being decoded to raw data that the first device uses to generate a representation.

23. The method of claim 21, wherein the capability information is information for determining whether the first device is capable of performing semantic communication, and the capability information includes a type of raw data, which the first device is capable of processing, and operation capability information of the first device.

24. The method of claim 21, wherein the semantic communication-related information includes at least one of a semantic data acquisition unit, a mini-batch size, an augmentation type and an augmentation ratio, or configuration information of an encoding model,
wherein the sematic data is data extracted from the raw data, and
wherein the acquisition unit, the augmentation type and the augmentation ratio are determined based on share information of the first device and the second device.

25. The method of claim 21, wherein the update of the share information is performed by using contrastive learning.

26. The method of claim 21, further comprising:
acquiring semantic data from raw data; and
generating augmentation data from the semantic data.

27. The method of claim 26, wherein the augmentation data is generated according to at least one of the augmentation type or the augmentation ratio that are determined based on the share information of the first device and the second device.

28. The method of claim 27, wherein the update of the share information is performed by using a transformed signal of the semantic communication signal, and
wherein the transformed signal is generated based on a data format that is used to perform the downstream task.

29. The method of claim 21, wherein the update of the share information is performed by using a transform head, and
wherein the transform head includes at least one dense layer and at least one non-linear function.

30. The method of claim 21, wherein the update of the share information is performed based on at least one result of learning for the downstream task.

31. The method of claim 30, wherein the learning for the downstream task is generated based on a first layer of the transform head and at least one layer that is determined to perform the downstream task.

32. The method of claim 30, wherein the learning for the downstream task includes a fine-tuning operation or a transfer-learning operation.

33. The method of claim 32, wherein the fine-tuning operation is performed for every network including a neural network, which is determined according to the downstream task, by using a weight of an encoder, a weight for an additional operation, and a weight for the first layer of the transform head, after pre-training is completed.

34. The method of claim 32, wherein the transfer-learning operation is performed for a multi-layer perceptron (MLP), which is added according to the downstream task, in a situation where the weight of the encoder, the weight for the additional operation, and the weight for the first layer of the transform head are fixed, after the pre-training is completed.

35. The method of claim 21, the semantic communication signal is transmitted in a layer for semantic communication.

36. A method comprising:
receiving a synchronization signal block (SSB);
performing synchronization based on the SSB;
performing initial access based on the SSB;
transmitting a capability information request to a first device;
receiving capability information from the first device;
in case that the first device being a device equipped with a semantic communication capability based on the capability information of the first device, transmitting semantic communication-related information to the first device; and
receiving a semantic communication signal generated based on the semantic communication-related information from the first device,
wherein the semantic communication signal is related to share information, and
wherein an update of the share information is performed based on an operation of a downstream task performed in a second device.

37. A first device comprising:
a transceiver; and
a processor coupled with the transceiver,
wherein the processor is configured to:
receive a synchronization signal block (SSB);
perform synchronization based on the SSB;
perform initial access based on the SSB;
receive a capability information request for the first device from a second device,
transmit capability information of the first device to the second device,
in case that the first device being a device equipped with a semantic communication capability based on the capability information of the first device, receive semantic communication-related information from the second device,
generate a semantic communication signal based on the semantic communication-related information, and
transmit the semantic communication signal to the second device,
wherein the semantic communication signal is related to share information, and
wherein an update of the share information is performed based on an operation of a downstream task performed in the second device.

38. The first device of claim 37, wherein the semantic communication signal is used by the second device to perform the downstream task without being decoded to raw data that the first device uses to generate a representation.

39. The first device of claim 37, wherein the capability information is information for determining whether the first device is capable of performing semantic communication, and the capability information includes a type of raw data, which the first device is capable of processing, and operation capability information of the first device.

40. The first device of claim 37, wherein the semantic communication-related information includes at least one of a semantic data acquisition unit, a mini-batch size, an augmentation type and an augmentation ratio, or configuration information of an encoding model,
wherein the sematic data is data extracted from the raw data, and
wherein the acquisition unit, the augmentation type and the augmentation ratio are determined based on share information of the first device and the second device.
